(19) United States
(12) Patent Application Publication
(10) Pub. No.: US 2018/0111221 A1
(43) Pub. Date: Apr. 26, 2018

(54) ARCUATE BOOM FOR FRICTION STIR WELDING OF ARCUATE WORK PIECES

(71) Applicant: ESAB AB, Gothenburg (SE)

(72) Inventors: Hakan Larsson, Laxa (SE); Hakan Persson, Askersund (SE); Tommy Svallin, Mariedamm (SE)

(21) Appl. No.: 15/628,242

(22) Filed: Jun. 20, 2017

Related U.S. Application Data
(60) Provisional application No. 62/410,928, filed on Oct. 21, 2016.

(51) Int. Cl. B23K 20/12; B29C 65/06; B29C 65/00

(52) U.S. Cl. CPC B23K 20/1245; B23K 20/1255; B29C 66/81264; B23K 20/129; B29C 65/0681; B23K 20/127

(57) ABSTRACT

The present disclosure is directed to a Friction Stir Welding device for welding one or more arcuate work pieces. The device including an arcuate boom, a friction stir welding head, and a saddle operatively coupling the welding head to the arcuate boom for moving the welding head with respect to the arcuate boom. The saddle may be coupled to the arcuate boom via a drive mechanism for moving the saddle, and the welding head that is coupled thereto, with respect to the arcuate boom. The welding head may also be provided with three degrees of freedom with respect to the arcuate boom so that the welding head can rotate, tilt and move linearly with respect to the arcuate boom.

### CROSS-REFERENCE TO RELATED APPLICATIONS

This application is a non-provisional of pending U.S. Provisional Patent Application Ser. No. 62/410,928, filed Oct. 21, 2016, titled “Arcuate Boom for Friction Stir Welding of Arcuate Work Pieces”, the entirety of which application is incorporated by reference herein.

### FIELD OF THE DISCLOSURE

The present disclosure generally relates to friction stir welding. More specifically, the present disclosure relates to an apparatus and method utilizing an arcuate boom for friction stir welding of arcuate work pieces.

### BACKGROUND OF THE DISCLOSURE

Friction stir welding is a well-known and proven welding method which, among other things, can be used to fit together work pieces and for repair of cracks in a work piece. When work pieces are joined to each other with the aid of friction stir welding, the edges of the work piece become plasticized along their joining line by frictional heating from a rotating welding tool that traverses the seam between the work pieces while simultaneously being pressed against the work pieces, which, during the welding operation, are to be fixed relative to each other.

The friction welding apparatus generally includes a rotating body which, during the welding operation, is pressed against the work pieces and a pin that extends out from the body which is guided forward while rotating in the seam between the work pieces in pressing action with the work pieces. As is described in WO 93/10935 A1 and WO 95/26254 A1, the welding tool is to be manufactured of a material harder than the work pieces. The welding tool can be made to traverse the seam between the work pieces by moving the welding tool along, with the work pieces placed stationary, or by moving the work pieces relative to a welding tool placed in stationary fashion.

With friction stir welding, the welding tool must be pressed with great force against the work pieces to make it possible to frictionally heat them enough to cause the desired plasticizing of the work pieces in the seam between them.

One drawback with this solution, however, is that friction stir welding is a sensitive welding process and requires the use of expensive welding tools. In addition, in order to achieve the down-forces necessary to weld very large work pieces, the welding apparatus needs to be very large and often, excessively heavy (e.g., upwards of 100 tons). Another drawback is that in order to perform friction stir welding of large domes, radial or curved seams, a large gantry or a column and boom carrier has been used to provide the necessary lateral and vertical (i.e., X and Y) movement of the friction stir welding head. This means that the lateral and vertical movements of the friction stir welding head are large to be able to follow the shape of the work pieces being joined.

In view of the forging, it would be desirable to provide an improved device and method that overcomes the deficiencies and limitations associated with the prior art devices.

### SUMMARY OF THE DISCLOSURE

The present disclosure is directed to a Friction Stir Welding (FSW) device for welding one or more arcuate work pieces. The FSW device includes an arcuate boom, a friction stir welding head, and a saddle operatively coupling the welding head to the arcuate boom for moving the welding head with respect to the arcuate boom.

The welding head may be configured to move with respect to the boom in three degrees of freedom so that the welding head can rotate, tilt and move linearly with respect to the boom.

The saddle includes a drive mechanism for engaging the arcuate boom so that operating the motor causes the saddle, and the welding head that is coupled thereto, to move with respect to the arcuate boom.

The saddle may include a body portion for engaging the arcuate boom and a head portion for engaging the welding head. The head portion may be rotationally coupled to the body portion. Alternatively, or in addition, the head portion of the saddle is pivotably coupled to the welding head. The body portion of the saddle includes a motor for engaging a drive rail located on the arcuate boom. Alternatively, or in addition, the body portion of the saddle includes first and second rail systems for engaging first and second tracks located on the arcuate boom so that driving the motor moves the saddle, and hence the welding head, along a curvature of the arcuate boom.

The head portion of the saddle may have a generally U-shaped member for receiving the welding head therein so that the welding head is pivotably coupled to the head portion. That is, the head portion of the saddle may include a top member having first and second arms extending therefrom, the first and second arms include first and second holes formed therein for aligning with a borehole formed in the welding head. The borehole and first and second holes receive a pin for pivotably securing the welding head to the head portion of the saddle. The head portion of the saddle may also include a stem extending from the top member thereof, the stem being disposed within one or more holes formed in the body portion of the saddle for rotatably engaging the head portion to the body portion.

The arcuate boom includes a top surface, a bottom surface, a first side surface and a second side surface, the first side surface including first and second tracks for engaging corresponding first and second rails disposed on the saddle. The first side surface may also include a drive track for engaging a motor disposed on the saddle so that driving the motor causes the saddle, and hence the welding head, to move along the first and second tracks.

### BRIEF DESCRIPTION OF THE DRAWINGS

By way of example, specific embodiments of the disclosed device will now be described, with reference to the accompanying drawings, in which:

FIG. 1 illustrates a perspective view of a friction stir welding device according to the present disclosure showing its dome in a lowermost position;

FIG. 2 illustrates a side view of the friction stir welding device illustrated in FIG. 1 but with the dome in its uppermost position;

FIG. 3 illustrates a perspective view of an arcuate boom used in connection with the device of FIG. 1;

FIG. 4A illustrates a side view of the arcuate boom illustrated in FIG. 3;

FIG. 4B illustrates a front view of the arcuate boom illustrated in FIG. 3;

FIG. 5 illustrates a perspective detail view of a saddle and welding head used in connection with the device of FIG. 1;

FIG. 6A illustrates a perspective detail view from another angle of the welding head coupled to the saddle shown in FIG. 5;

FIG. 6B illustrates a side detail view of the welding head coupled to the saddle shown in FIG. 5;

FIG. 7 illustrates a perspective detail view of a head portion of the saddle shown in FIG. 5;

FIG. 8 illustrates a front view of the head portion of the saddle shown in FIG. 7;

FIG. 9 illustrates a side view of the head portion of the saddle shown in FIG. 7;

FIG. 10 illustrates a perspective detail view of the saddle coupled to the boom in connection with the device shown in FIG. 1;

FIG. 11 illustrates a side detail view of the saddle coupled to the boom in connection with the device shown in FIG. 1;

FIG. 12 illustrates a rear view of the saddle in connection with the device shown in FIG. 1;

FIG. 13 illustrates a perspective view of a welding head used in connection with the device shown in FIG. 1;

FIG. 14 illustrates a perspective view of a friction stir welding device according to the present disclosure including a support member for connecting to a work piece; and

FIG. 15 illustrates a perspective view of a friction stir welding device according to the present disclosure including an arcuate boom that extends 180 degrees.

### DETAILED DESCRIPTION

A device and method in accordance with the present disclosure will now be described more fully hereinafter with reference to the accompanying drawings, in which the device and method are shown. The disclosed device and method, however, may be embodied in many different forms and should not be construed as being limited to the embodiments set forth herein. Rather, these forms are provided so that this disclosure will be thorough and complete, and will fully convey the scope of the device and method to those skilled in the art. In the drawings, like numbers refer to like elements throughout.

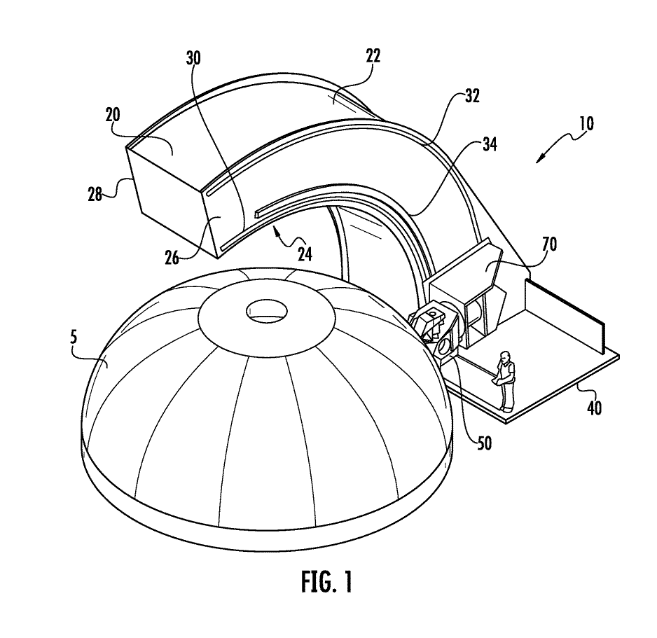

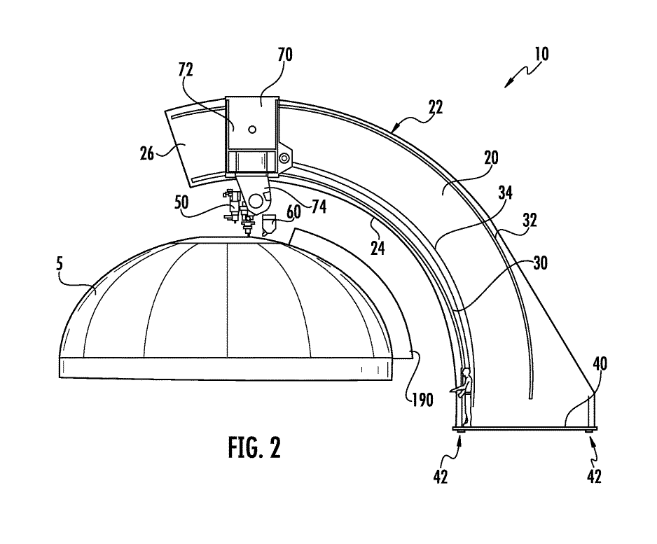

The present disclosure is directed to an improved device and method for friction stir welding of dome, radial or curved seams (collectively referred to herein as “arcuate surfaces”). Referring to FIGS. 1 and 2, the Friction Stir Welding (FSW) device 10 according to the present disclosure may include an arcuate welding carrier beam or boom 20, a friction stir welding head 50, and a saddle 70 operatively coupling the welding head 50 to the arcuate boom 20 for positioning, moving and supporting the welding head 50 along the boom with respect to a work piece 5. The arcuate boom extends at least slightly more than ninety degrees. In the illustrated embodiment, the work piece 5 has an arcuate dome-like shape and, as will be described in greater detail later, is composed of multiple individual plate elements having arcuate surfaces. As illustrated, the boom 20 may have a ninety degrees section that is concentric with respect to ninety degrees of the work piece so that it follows the contour of the arcuate shape of the work piece 5 to be welded. In this manner, the horizontal and vertical (i.e., X and Y) movements required to move the welding head 50 along the welding path are minimized. By utilizing an arcuate boom 20 that is substantially concentric about the work piece 5, the horizontal X and vertical Y movements required to appropriately position the welding head 50 may be reduced, thus decreasing the overall size and weight of the FSW device 10.

As can be seen in FIG. 2, the saddle 70 may include a body portion 72 and a head portion 74. The head portion 74 may be a U-shaped member for receiving the welding head 50. In use, the head portion 74 may be rotationally coupled to the body portion 72 of the saddle 70. In addition, the welding head 50 may be pivotably coupled to the head portion 74 of the saddle 70. The body portion 72 of the saddle 70 may also include a motor 110 and first and second rail systems 112, 114 (shown in FIG. 10) so that the saddle 70 may be driven along the boom 20. In this manner, the welding head 50 is able to move along, rotate and tilt with respect to the boom 20, thus enabling the user to position the welding head 50 with respect to the work piece 5 in any of a variety of orientations, as necessary.

As will be appreciated by one of ordinary skill in the art, the welding head 50 may be any welding head capable of friction stir welding, a non-limiting example of which is disclosed in U.S. Pat. No. 6,264,088 to Larsson, the disclosure of which is incorporated herein in its entirety, thereby permitting the description of the friction stir welding head to be omitted for the sake of convenience. An exemplary FSW welding head is illustrated in FIGS. 5, 6A, 6B, and 13.

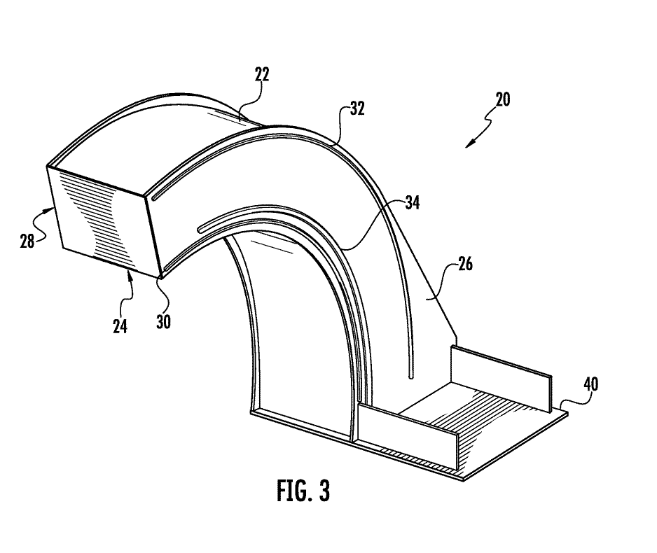

Referring to FIGS. 1-4B, the carrier beam or boom 20 may have an arcuate shape that is similar to the arcuate shape of the work piece 5 to be welded. By providing an arcuate boom 20 with a radius that is similar to the shape of the work piece 5 to be welded, the horizontal X and vertical Y movements required to appropriately position the welding head 50 may be minimized. That is, as previously described, since the welding head 50 is able to travel along the arcuate shape of the boom 20, movement of the welding head 50 in the vertical Y direction is reduced.

As previously mentioned, the friction stir welding process generally requires that a substantial force be applied to the workpiece via the welding head. As such, a high degree of stability and rigidity of the support arrangement for the welding head 50 is desired. By reducing the vertical Y stroke required to position the welding head 50 at various points along a curved path, the forces and torque on the FSW device 10 are greatly reduced. This makes it possible to reduce the size and weight of the FSW device 10. In addition, by positioning the welding head 50 along a curved path, the required tilting range of the welding head 50 can also be reduced.

The arcuate boom 20 includes a top surface 22, a bottom surface 24, a first side surface 26 and a second side surface 28 so that the cross-section of the boom 20 has a generally square cross-section, although other cross-sectional shapes are contemplated including, but not limited to, rectangular, trapezoidal, etc. The first side surface 26 includes first and second guide tracks 30, 32 for engaging corresponding rails 112, 114 disposed on the saddle 70 (as will be described in greater detail below). The guide tracks 30, 32 are arcuate so that they generally correspond to the shape of the arcuate boom 20. In addition, the first side surface 26 of the boom 20 may also include a drive rail 34 for engaging the motor 110 disposed on the saddle 70 (as will be described in greater detail below). The drive rail 34 may also be arcuate so that it generally corresponds to the shape of the arcuate boom 20. The motor 110 and drive rail 34 may be coupled by any means now known or hereafter developed including, for example, via a plurality of teeth formed on the drive rail 34 for engaging a gear (not shown) rotationally coupled to the motor 110, so that driving the motor 110 causes the saddle 70, and hence the welding head 50, to move along the guide tracks 30, 32.

The arcuate boom 20 may also be securely coupled at a bottom end to a platform 40. The platform 40 provides the user/operator with a location from which to monitor and control the operation of the FSW device 10. The platform 40 may also include a plurality of wheels 42 for riding on a rail system (not shown) for movably locating the FSW device 10. In this manner, the FSW device 10 may be movably positioned along the rail system to enable one to, for example, better access the work piece 5 and load/unload the work piece 5.

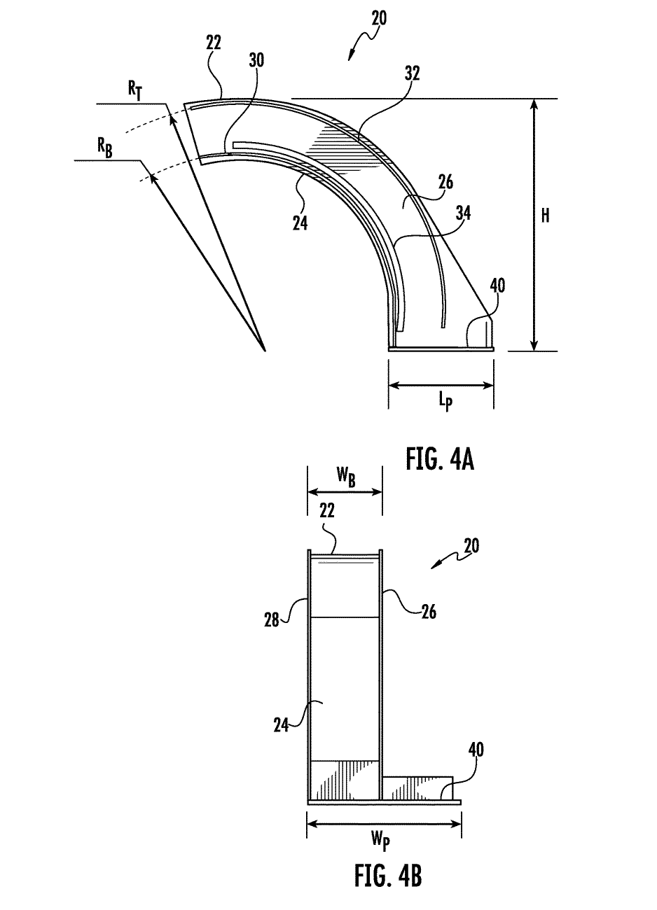

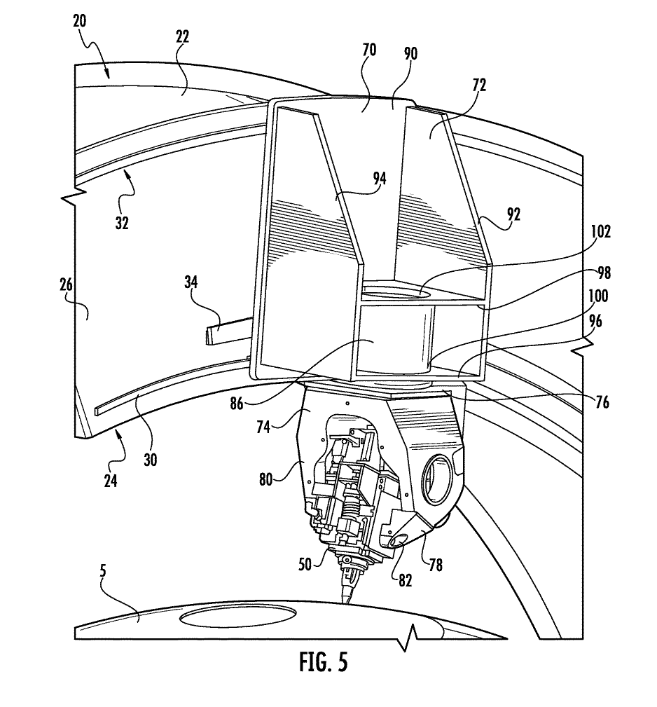

Referring to FIGS. 4A and 4B, in one non-limiting exemplary embodiment, the arcuate boom 20 may have an overall height H of approximately 9800 cm (approx. 26.75 feet), a width W_{B} of approximately 2830 cm (approx. 7.74 feet), the radius of curvature R_{T} of the top surface 22 is approx. 8000 cm (approx. 21.87 feet), and the radius of curvature R_{B} of the bottom surface 24 is approx. 6000 cm (approx. 16.40 feet). As illustrated, the platform 40 may have an approximately width W_{P} of 6000 cm (approx. 16.40 feet) and a length L_{P} of 4100 cm (approx. 11.21 feet), though it is contemplated that the arcuate boom 20 may be made smaller or larger to suit other welding applications without departing from the scope of the present disclosure.

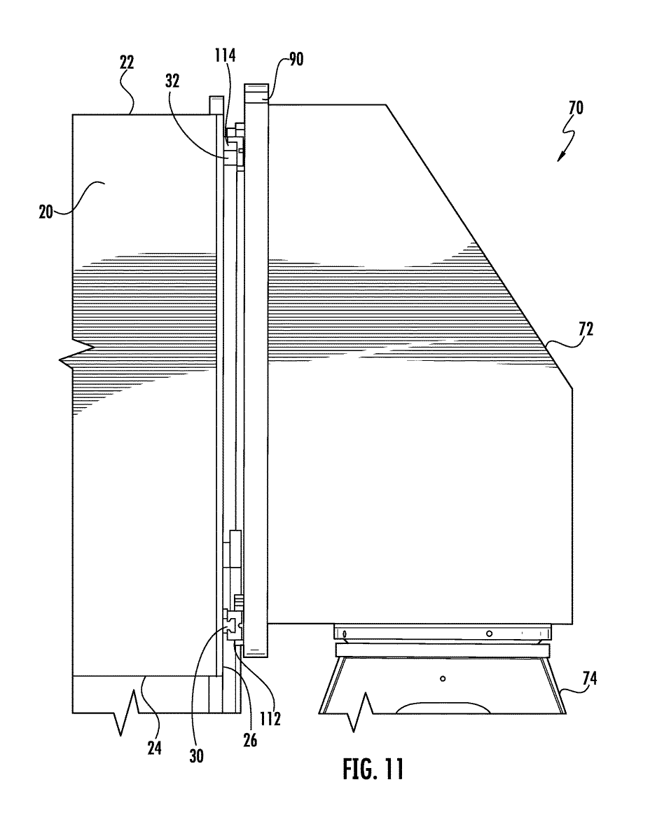

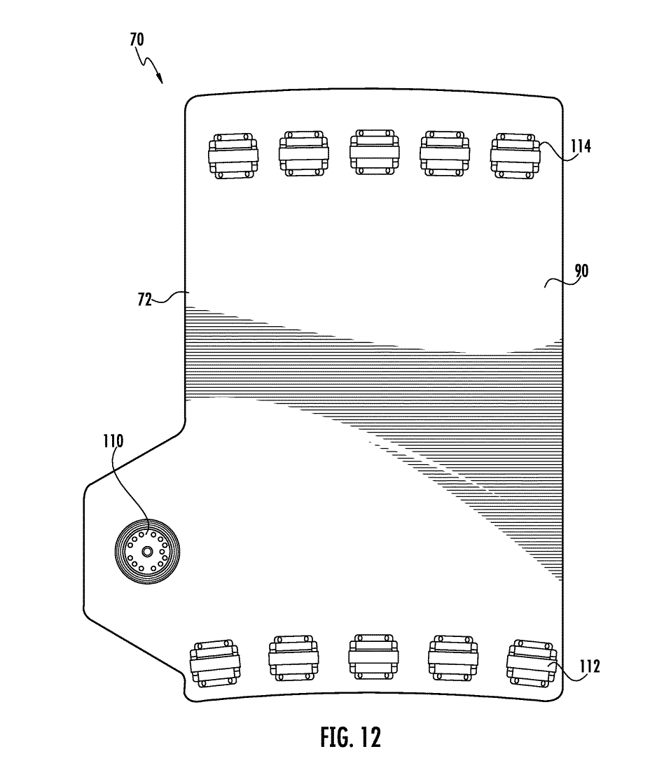

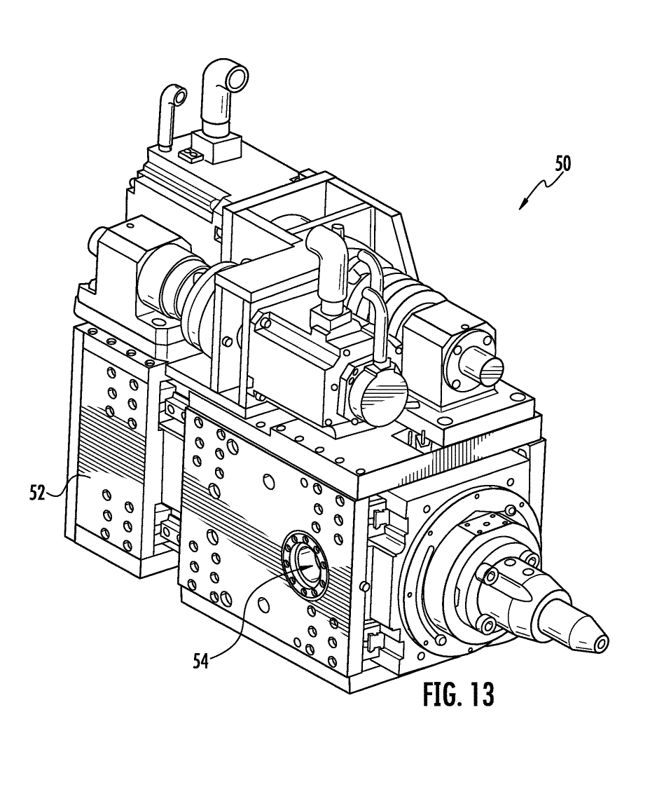

Referring to FIGS. 5 and 10-12, the saddle 70 may be coupled to the arcuate boom 20 by any means now known or hereafter developed that enables the saddle 70 to move along the arcuate boom 20. For example, the saddle 70 may be coupled to the arcuate boom 20 by a drive mechanism for moving the saddle 70, and hence welding head 50, with respect to the boom 20.

The saddle 70 may include a body portion 72 for movably engaging the arcuate boom 20 and a head portion 74 for engaging the welding head 50. The welding head 50 may be coupled to the head portion 74 of the saddle 70 by any means now known or hereafter developed. The head portion 74 of the saddle 70 may be coupled to the welding head 50 so that the welding head 50 can move with respect to the head portion 74 of the saddle 70. The welding head 50 may be coupled to the saddle 70 so that the welding head 50 may pivot with respect to the saddle 70.

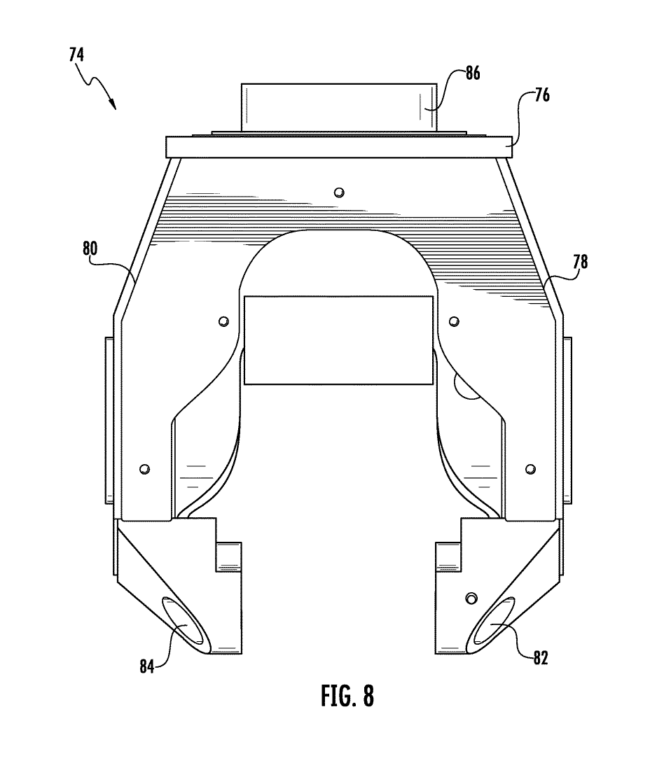

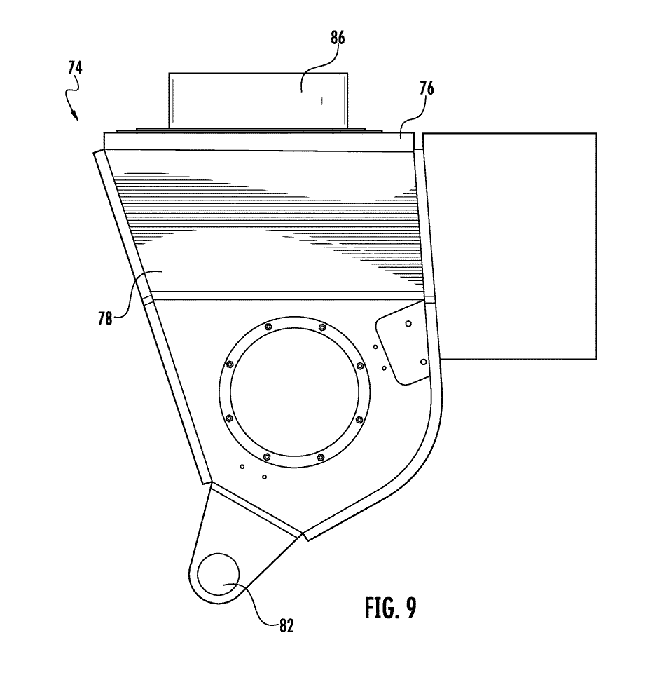

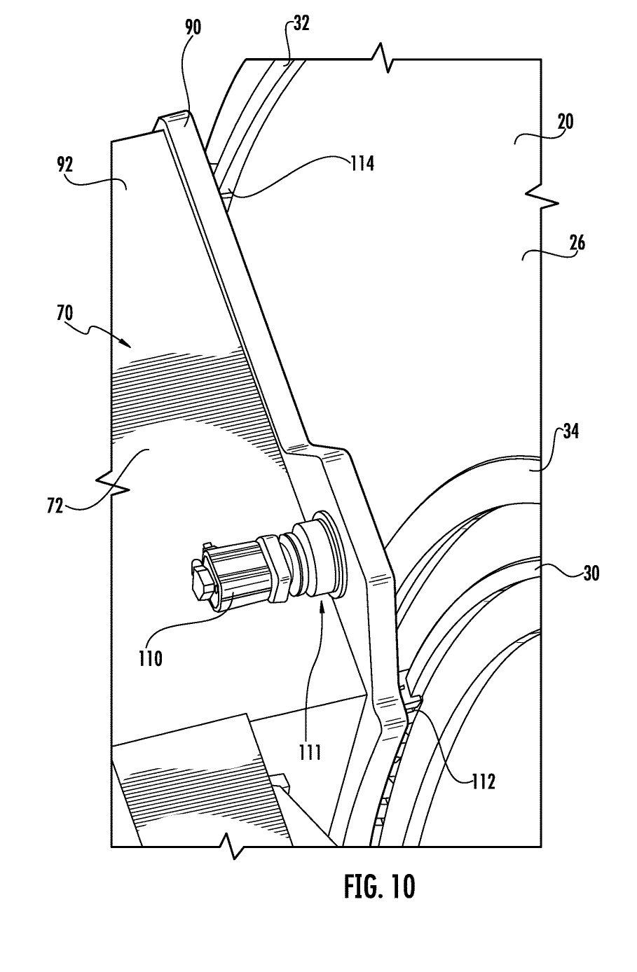

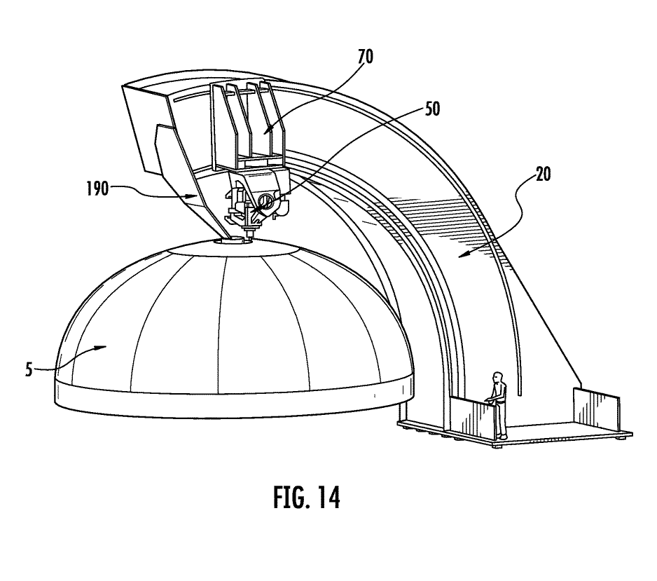

Referring to FIGS. 5-9, the head portion 74 may be a U-shaped member for receiving the welding head 50. That is, the head portion 74 may include a top member 76 having first and second arms 78, 80 extending therefrom. The first and second arms 78, 80 may include first and second holes 82, 84, respectively, formed therein. In use, the holes 82, 84 formed in the first and second arms 78, 80 of the head portion 74 are aligned with corresponding holes 54 formed in a body portion 52 of the welding head 50 (FIG. 13) for receiving respective pins therethrough. In this manner, the welding head 50 may be secured to the head portion 74 of the saddle 70 while still enabling the welding head 50 to pivot or tilt with respect to the saddle 70 about the axis of the pins and corresponding holes. While the head portion 74 of the saddle 70 has been described as being in the form of a generally U-shaped member, it is contemplated that the head portion 74 may take on other forms capable of securely holding the welding head 50 and allowing the welding head 50 to pivot with respect to the saddle 70. In addition, while the welding head 50 has been described as being coupled to the head portion 74 of the saddle 70 via a pin connection or connections, other means of providing a pivotable connection are contemplated.

The head portion 74 of the saddle 70 may also include a stem 86 extending from the top member 76. As illustrated, the stem 86 may extend in a direction opposite from the direction of the first and second arms 78, 80. In use, the stem 86 may extend into one or more holes 100, 102 formed in the body portion 72 of the saddle 70 for securely coupling the head portion 74 to the body portion 72 (as will be described in greater detail).

Referring to FIGS. 5 and 10-12, the body portion 72 of the saddle 70 may include a back member 90 with first and second members 92, 94 extending perpendicularly therefrom, and a bottom member 96 extending between the first and second members 92, 94. The body portion 72 may also include an intermediate member 98 parallel to the bottom member 96 for providing additional support. The bottom member 96 and intermediate member 98 include holes 100, 102, respectively, for receiving the stem 86 extending from the body portion 74. In this manner, the head portion 74 may be fixedly secured to the body portion 72 while still enabling rotation of the head portion 74, and hence the welding head 50, with respect to the body portion 72. As will be appreciated, the disclosed arrangement provides a second degree of rotation of the welding head 50 with respect to the boom 20. Thus, in the illustrated embodiment, the axis of rotation of the head portion 74 with respect to the body portion 72 is orthogonal to the axis of rotation of the welding head 50 with respect to the head portion 74. The head portion 74 may be rotationally coupled to the body portion 72 by any means now known or hereafter developed including, but not limited to, rotational bearings, drive gears, etc. In one exemplary embodiment, the body portion 72 includes an electrical motor and gearbox (not shown) for engaging with a circular rack and pinion on the head portion 74 so that activation of the motor rotates the head portion 74 and hence the welding head 50, with respect to the body portion 72 and hence the boom 20.

While the body portion 72 of the saddle 70 has been described as including a back member 90 with first and second members 92, 94 extending therefrom, it is contemplated that the body portion 72 may take on other forms capable of securely holding the head portion 74 and hence the welding head 50. In addition, while the body portion 72 and the head portion 74 have been described as being separate pieces, it is contemplated that they could be made as a single, integrated piece.

As best seen in FIGS. 10-12, the back member 90 may have a motor 110 mounted thereto. The motor 110 may have a gearbox 111 extending therethrough for engaging the drive rail 34 located on the arcuate boom 20. In addition, the back member 90 may include first and second rail systems 112, 114 for engaging the first and second tracks 30, 32 located on the arcuate boom 20. As will be appreciated, the first and second rail systems 112, 114 may be sized and shaped to correspond to the size and arcuate shapes of the associated guide tracks 30, 32. In this manner, the saddle 70, and hence the welding head 50, may be driven along the curvature of the boom 20 via the first and second rail systems 112, 114 which are movable along the first and second tracks 30, 32. As such, the welding head 50 is able to move along, rotate and tilt with respect to the boom 20, thus enabling the user to orient the welding head 50 in any of a variety of positions with respect to the work piece 5, as desired.

In use, the FSW device 10 may be controlled by a computer numeric control (CNC) system, which may include an arrangement for applying a desired adjustable force to the welding head 50.

The welding head 50 may include a bobbin pin/shoulder arrangement such as that disclosed in U.S. Pat. No. 7,156,275 to Larsson. Using a bobbin-type friction stir welding head may enable a further decrease in the size and weight of the arcuate boom 20, due to the reduced down-force required to be applied to the adjoining plate segments of the work piece 5.

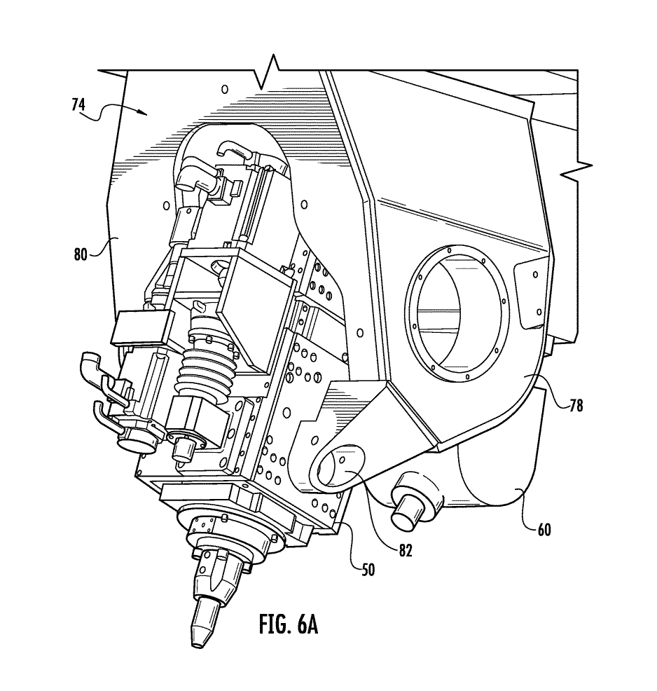

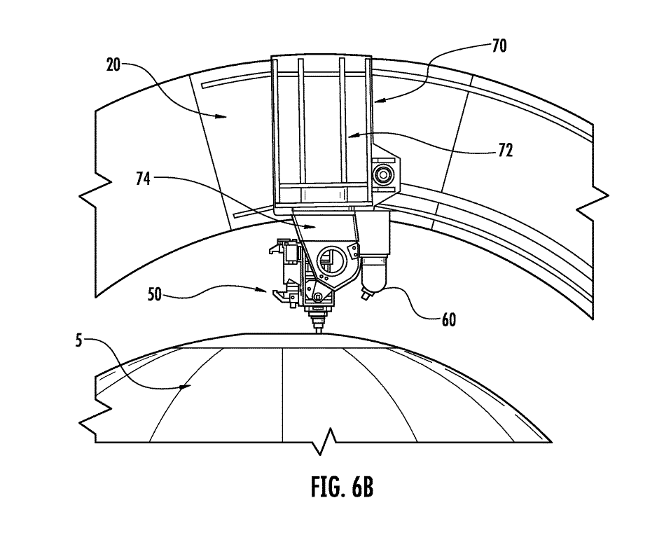

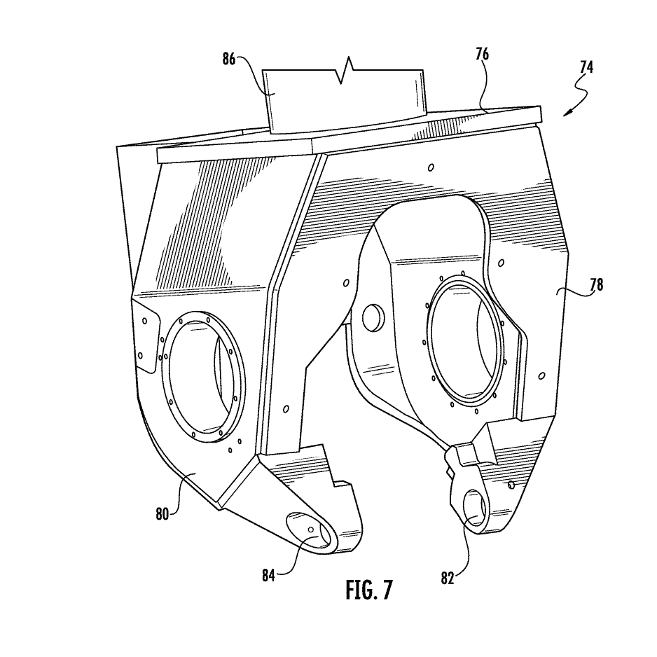

The FSW device 10 may also incorporate a milling head 60. Referring to FIGS. 2, 6A, and 6B, the FSW device 10 may include a milling head 60 attached to the head portion 74 of the saddle 70. In use, by incorporating a milling head 60, the FSW device 10 is also able to perform weld preparation. By coupling the milling head 60 to the saddle portion 70, the milling head 60 is also able to have three degrees of freedom with respect to the boom 20 (e.g., linear movement, tilt and rotate). The milling head 60 may be independently positionable with respect to the welding head 50.

Thusly arranged, the FSW device 10 may be used to controllably move the welding head 50 along the curved paths defined by adjoining plate members of the work piece 5 to obtain a unitary dome shaped work piece. The FSW device 10 may also be used to move the welding head 50 along the circular path defined by the bottom ring-shaped member (see FIG. 1) to join that member to the other plate members. The FSW device 10, as described may facilitate this controllable positioning with a reduced vertical (Y-direction) stroke, thus enabling a more compact arrangement of the arcuate boom 20 as compared to traditional X-Y gantry systems or column and boom systems.

Referring again to FIG. 14, the FSW device 10 may also include a support member 190 that may be operatively connected to the fixture holding the work piece 5 to provide for increased stiffness of the work piece 5 during the friction stir welding process. Alternatively, referring to FIG. 2, the support member 190 may be separate from the arcuate boom 20 and may extend along the outer surface of the work piece 5 for providing increased stiffness of the work piece 5 during the friction stir welding process.

The FSW device 10 may also include one or more hinges (not shown) to enable portions of the FSW device 10 to be foldable or movable relative to other portions of the FSW device 10 to enable better access to the work piece 5. For example, the arcuate boom 20 may include a hinge at or near its connection to the platform 40 so that the arcuate boom 20 can be tilted with respect to the platform 40 enabling one to, for example, better access the work piece 5 from above or load/unload the work piece 5.

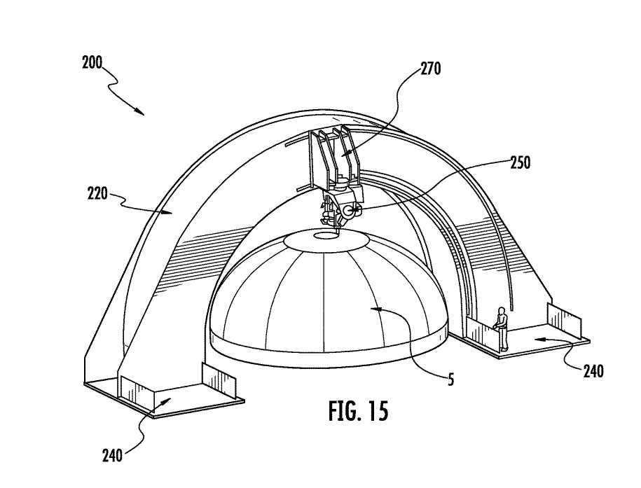

Referring to FIG. 15, FSW device 200 is substantially similar to the FSW device 10 described above except as described herein. As shown, the arcuate boom 220 may extend one-hundred-eighty degrees around the work piece 5. The FSW device 200 may include first and second platforms 240, one of either side of the work piece 5. As will be appreciated by one or ordinary skill in the art, by providing an arcuate boom 220 that extends one-hundred-eighty degrees and that contacts the ground in two locations, the FSW device 200 has increased stability and reduced stresses and loads on the arcuate boom 220. In addition, while the welding head 250 and saddle 270 are illustrated as extending approximately ninety degrees, it will be appreciated that the welding head 250 and the saddle 270 may extend more or less, including but not limited to one-hundred-eighty degrees (or the entire length of the boom 220).

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

While certain embodiments of the disclosure have been described herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

1. A Friction Stir Welding device for welding one or more arcuate work pieces comprising:
an arcuate boom;
a friction stir welding head; and
a saddle operatively coupling the welding head to the arcuate boom for moving the welding head with respect to the arcuate boom.

2. The welding device of claim 1, wherein the welding head is pivotable with respect to the saddle.

3. The welding device of claim 2, wherein the saddle is adapted and configured to enable the welding head to rotate with respect to the boom.

4. The welding device of claim 1, wherein the saddle is operatively coupled to the arcuate boom via a drive mechanism for moving the saddle, and the welding head that is coupled thereto, with respect to the arcuate boom.

5. The welding device of claim 1, wherein the saddle comprises a body portion and a head portion, the body portion operatively engaging the arcuate boom, the head portion operatively engaging the welding head, the head portion being rotationally coupled to the body portion.

6. The welding device of claim 5, wherein the head portion is pivotably coupled to the welding head.

7. The welding device of claim 5, wherein the body portion of the saddle includes a motor for engaging a drive rail located on the arcuate boom.

8. The welding device of claim 7, wherein the body portion of the saddle further includes first and second rail systems for engaging first and second tracks located on the arcuate boom so that driving the motor moves the saddle, and hence the welding head, along a curvature of the arcuate boom.

9. The welding device of claim 5, wherein the head portion has a generally U-shaped member for receiving the welding head therein so that the welding head is pivotably coupled to the head portion.

10. The welding device of claim 5, wherein the head portion of the saddle includes a top member having first and second arms extending therefrom, the first and second arms including first and second holes formed therein for aligning with respective holes formed in the welding head and for receiving one or more pins for pivotably securing the welding head to the head portion of the saddle.

11. The welding device of claim 10, wherein the head portion of the saddle includes a stem extending from the top member thereof, the stem being disposed with one or more holes formed in the body portion of the saddle for rotatably engaging the head portion to the body portion.

12. The welding device of claim 5, wherein body portion of the saddle includes a motor operatively coupled to the arcuate boom so that the saddle is movable with respect to the arcuate boom by the motor.

13. The welding device of claim 1, wherein the arcuate boom includes a top surface, a bottom surface, a first side surface and a second side surface, the first side surface including first and second tracks for engaging corresponding first and second rails disposed on the saddle; the first side surface includes a drive track for engaging a motor disposed on the saddle so that driving the motor causes the saddle, and hence the welding head, to move along the first and second tracks.

14. The welding device of claim 1, further comprising a platform coupled to the arcuate boom, the platform including a plurality of wheels for riding on a rail system to movably position the device.

15. The welding device of claim 1, wherein the arcuate boom has a radius of curvature that substantially corresponds to a radius of curvature of at least one of the one or more arcuate work pieces.

16. The welding device of claim 1 wherein the operative coupling of the welding head to the arcuate boom is such that the welding head has three degrees of motion freedom with respect to the arcuate boom, permitting the welding head to rotate, tilt and move linearly with respect to the arcuate boom.

17. The welding device of claim 1 wherein the arcuate boom extends through an angle of at least ninety degrees.

18. The welding device of claim 1 wherein the arcuate boom extends through an angle of one-hundred-eighty degrees.
